(19) United States
(12) Patent Application Publication
(10) Pub. No.: US 2025/0229267 A1
(43) Pub. Date: Jul. 17, 2025

(54) Adhesive Film for a Microfluidic Device, Microfluidic Device with Adhesive Film, and Use of an Adhesive Film for Closing an Opening of a Microfluidic Device

(71) Applicant: Robert Bosch GmbH, Stuttgart (DE)

(72) Inventors: Julian Kassel, Pforzheim (DE); Sonja Knies, Rutesheim (DE); Martina Budde, Karlsruhe (DE)

(21) Appl. No.: 18/700,511

(22) PCT Filed: Sep. 7, 2022
(86) PCT No.: PCT/EP2022/074793

§ 371 Date: Apr. 11, 2024

(30) Foreign Application Priority Data
Oct. 13, 2021 (DE) 10 2021 211 545.4

(51) Int. Cl. B01L 3/00

(52) U.S. Cl. CPC B01L 3/502707; B01L 2300/044

(57) ABSTRACT

An adhesive film for sealing an opening of a microfluidic device, in particular an opening for feeding or removing substances is disclosed. The adhesive film includes a protective film. Additionally disclosed is a microfluidic device that includes an adhesive film and to the usage of an adhesive film by a microfluidic device.

### PRIOR ART

When using microfluidic systems, in particular what are referred to as lab-on-a-chip systems in the biomolecular or medical field, microfluidic cartridges are often used in which substances and reagents required for performing analyses are stored in the cartridge in advance, in particular in freeze-dried form. The cartridges are designed to seal as well as possible in order to prevent substances from escaping from the cartridge into the environment and to prevent contamination of the cartridges by substances from the environment.

For example, a microfluidic system comprising a cartridge as described in DE 10 2016 222 075 A1 or DE 10 2016 222 072 A1 can be used to detect pathogens in a biological sample, e.g. in the form of a PCR test for detecting influenza or corona viruses. For this purpose, the reagents required for the polymerase chain reaction are preferably stored in the cartridge in advance and are already placed in the designated chamber of the cartridge during the production of the cartridges.

### DISCLOSURE OF THE INVENTION

### Advantages of the Invention

Against this background, the invention relates to an adhesive film for sealing an opening of a microfluidic device, in particular a microfluidic cartridge, whereby the adhesive film comprises a protective film. The opening is preferably an opening for feeding substances into the device and/or for removing substances from the device. The invention further relates to a microfluidic device, in particular a microfluidic cartridge comprising an adhesive film, the adhesive film preferably comprising a protective film. The adhesive film can preferably be arranged on the device, in particular at least partially adhered, and can cover an opening of the device.

In particular, the adhesive film is a self-adhesive film made of plastic, whereby one side of the adhesive comprises an adhesive for adhering the film. Preferably, said film remains stable up to at least 110 degrees Celsius, meaning in particular that it cannot detach due to, e.g., failure of the adhesive or curvature of the film. Furthermore, the adhesive film is preferably (bio) compatible so as not to contaminate or damage fluids and reagents in the cartridge or assays running in the cartridge. For example, the film can be what is referred to as a PCR film (“PCR” being the abbreviation for polymerase chain reaction), e.g. a film such as 3M™ Microfluidic Diagnostic Tape 9795R, or the film can be based on such a film.

The protective film is in particular a film comprising plastic, which is applied to the adhesive side of the adhesive film. Therefore, the protective film advantageously prevents the adhesive side from adhering to another object. The adhesive film, the adhesive, and at least a section of a surface of the protective film are selected and/or designed such that at least regions of the protective film can be detached from the adhesive film by being peeled away, whereby at least a section of the adhesive, preferably as much of the adhesive as possible, remains on the adhesive film. For example, the protective film can be a polyester film.

The term “substances” is in particular understood to mean solid substances, liquid substances, or mixtures of substances. In particular, the substances can be one or multiple solid or liquid reagents intended to be introduced into the device for an operation, in particular reagents for performing an assay or nucleic acid amplification, e.g. what is referred to as a (PCR) mastermix. In particular, the substances being removed from the opening can be fluids or liquids intended be removed from the device during or after use of the device for, e.g., subsequent processing or analysis outside the device.

The device can preferably be a device for processing microfluidic fluids and/or samples, i.e. fluids and samples in the milliliter or microliter range in particular. The device can be a lab-on-a-chip device or part of a lab-on-a-chip system. For example, the device is based on a microfluidic cartridge described in DE 10 2016 222 075 A1 or DE 10 2016 222 072 A1. Particularly in the case of a cartridge design, the device can comprise a layered structure, whereby a fluidic structure for processing a sample received in the device is formed in at least one layer. The fluidic structure can comprise multiple channels, chambers, and/or valves for this purpose. The opening of the device is preferably an opening into a reagent chamber, in particular a mastermix reagent chamber. A reagent chamber or master mix reagent chamber is a chamber that is designed to store reagents or reagents for a (PCR) master mix, meaning in particular that it contains no contaminants, e.g. fats or oils that could affect these reagents. Alternatively, the opening can be an opening into another chamber in order to, e.g., remove substances or fluid from the chamber.

The invention has the advantage that substances can be introduced into or removed from the preferably ready-made device via the opening in the device, whereby the opening can be sealed with the adhesive film in a simple and well-defined manner before and after introduction or removal and, in particular, covered. As a result, a fluidic network in the device connected to the opening can be closed in a fluidically sealed manner against an environment outside the device, and the device can advantageously be used like a comparable device not comprising such an opening. Particularly advantageously, the invention can be used to subsequently introduce into the device substances required for nucleic acid amplification, in particular a polymerase chain reaction or isothermal amplification, e.g. a PCR bead (which can be understood to mean a bead, in particular freeze-dried, comprising multiple reagents required for the PCR). This has the advantage that the manufactured device can be used for various applications and using various reagents or, if necessary, substances already contained can be removed or exchanged via the opening. The device can thereby advantageously also be part of what is referred to as a laboratory-developed test (abbreviated as LDT) and be referred to as an LDT device, in particular an LDT cartridge, i.e., in particular as a device that does not yet form a complete biological test, but is only combined to form an operational test by introducing reagents via the opening that can be sealed by adhesive film.

Preferably, parts or portions of the adhesive film are transparent. Very preferably, the adhesive film is transparent at least within a specified temperature range, e.g. within a temperature range used for a polymerase chain reaction, e.g. from 0 or 20° C. to 100 or 110° C. In other words, at least parts, regions, and/or portions of the film are preferably transparent. In the present context, the term “transparency” preferably means transparency for electromagnetic radiation in the range of the wavelength spectrum visible to humans. This has the advantage that transparency of the device is not impaired by the applied film, in particular transparency of chambers of the device which is intended for observation or measurement of processes taking place in the chambers, such as a quantitative real-time polymerase chain reaction based on fluorescence. The protective film can be transparent or non-transparent. Given an at least partially transparent adhesive film, the protective film is preferably not transparent. As a result, the user is able to immediately detect the transparent regions of the adhesive film on which the protective film is located.

In a particular embodiment, the adhesive film does not comprise any adhesive in a region that covers the opening. Alternatively, this region is covered by the protective film. This has the advantage that the probability of adhesive entering the device through the opening is reduced.

According to a particularly preferred embodiment of the invention, the adhesive film is structured and/or trimmed such that no entire surface of the device is covered by the adhesive film. Preferably, at least one chamber of the device is not covered by the adhesive film. In addition to not wasting material, this has the particular advantage that chambers and channels, especially in a transparent layer of the device, are not covered by the adhesive film, making optical inspection or selection more difficult.

According to a further particularly preferred embodiment of the invention, the adhesive film comprises a tab. Preferably, the adhesive film is applied to the device such that the tab covers the opening. This has the advantage that the opening can be made accessible by moving the tab away without having to move the entire adhesive film, so the remainder of the film can remain attached to the device unchanged. The term “tab” therefore refers in particular to a section of the adhesive film which is connected to the remainder of the adhesive film, but can be moved without moving the remainder of the film. The tab can preferably only be connected to the remainder of the adhesive film on one side. At least parts or portions of the tab can be formed by incisions in the adhesive film. The first tab can therefore comprise a first incised region of the adhesive film. The incised region is preferably formed by at least one incision or gap, preferably by two incisions or gaps in the adhesive film. For example, the tab comprises a first section, which corresponds to a section protruding from the remainder of the film, and a second section, which is delimited by one or multiple incisions in the film. The protective film can also preferably comprise incisions or gaps in order to selectively detach sections of the protective film from the adhesive film.

In a particularly preferred embodiment of the invention, the tab, in particular the incised region, comprises at least a section of the protective film, which section is able to be peeled away. The protective film is preferably attached to the adhesive side of the adhesive film. This has the advantage that the tab is not initially adhered to the device after the film has been applied to the device, but preferably only covers the opening and can only be adhered if necessary, after the protective film has been peeled away. Advantageously, the opening can therefore be easily accessible to the user by folding away the tab and, if necessary, especially after inserting substances through the opening or removing them from the opening, it can be closed by adhering the tab after the protective film has been peeled away. Therefore, the incised region of the tab in particular preferably comprises the removable protective film on a side facing the opening, which side preferably corresponds to the side of the incised region provided with adhesive, which side can be peeled away.

In a particularly advantageous embodiment of the invention, the adhesive film comprises a second tab, in particular for covering a further opening of the device. The further opening can be an opening into a further chamber of the device, in particular a chamber, into which a substance being processed in the device, in particular a sample being processed, is conveyed.

According to a particular embodiment of the invention, the first tab and/or the second tab comprise a protrusion for moving the first or second tab. In this context, the term “protrusion” can be understood to mean a section of the adhesive film that protrudes from the remainder of the adhesive film, as in the case of the first section of the tab described hereinabove.

According to a further particular embodiment of the invention, a section of the adhesive film is separated from the remainder of the adhesive film by an incision or gap and joined by a section of the protective film. In other words, the section of the protective film is connected to both the section and the remainder of the adhesive film and extends across the incision or gap. As a result, the section and the remainder of the adhesive film advantageously remain connected to one another (not directly, but indirectly) via the protective film. It is also advantageous that the section of adhesive film can be removed from the remainder of the adhesive film together with the section of the protective film, thereby exposing at least regions of the remainder of the adhesive film for a bonding process, in particular to the device.

In one particular embodiment of the invention, the adhesive film, the first tab in particular comprises a marking for attaching/adhering a substance, in particular a reagent such as a PCR bead. This has the advantage of indicating to the user the location where a substance should be applied onto the adhesive film, in particular onto the tab, for a well-defined use. Preferably, the marking is positioned on the adhesive film such that the marking is located on a device above the opening when the adhesive film is used as intended. In a particular embodiment, the adhesive film is attached to the device, in particular adhered, such that the marking is located above the opening. This has the advantage that a substance fixed to or within the marking can be released via fluid through the opening, especially if the adhesive film seals the opening such that the substance is located in the opening or above the opening. In particular, the marking can be a cross or a closed line, e.g. a circle, an ellipse, or a rectangle. As a result, the user is advantageously notified that they should place the substance on the cross or within the closed line. In one specific embodiment, the marking can also comprise an inscription, in particular for instructions to the user.

The object of the invention is also usage of the adhesive film according to the invention, in which an opening of a microfluidic device is covered by the adhesive film. Preferably, the opening is sealed by the adhesive film after a substance has been introduced into the device via the opening, or after a substance has been removed from the device through the opening. For this purpose, a protective film is preferably pulled away from of the adhesive film, in particular from a tab of the adhesive film. The adhesive film, in particular the tab, is then adhered over the opening. Such a usage can also be understood as a method for introducing or removing a substance via an opening of a microfluidic device comprising an adhesive film according to the invention.

According to a particularly preferred embodiment of said usage, the protective film is at least partially removed, and an adhesive region of the adhesive film exposed by the removal, in particular at least one section of the first tab, is connected to the device, in particular after the introduction of a substance or after the removal of a substance through the opening.

According to a further particularly preferred embodiment of the usage, the adhesive film is adhered to the device, whereby at least one section of the first tab comprises the protective film. In a particular embodiment, this can be performed as part of the manufacture of the device, in particular the cartridge. Preferably, the protective film is removed from the tab, and the tab is adhered to the device after a substance has been introduced or removed through the opening. This has the advantage that the opening through the non-adhesive tab initially remains easily accessible, even after the adhesive film has been adhered and, when required, the tab is only connected to the device via adhesive. According to a particular embodiment of the usage, the adhesive film further comprises a second tab for covering the further opening, whereby the second tab also comprises a removable protective film, and whereby the protective film is removed from the second tab after the adhesive film has been adhered to the device, and preferably after a substance has been introduced or removed through the second opening and the second tab is adhered to the device.

With regard to the advantages of usage according to the invention, reference is made to the advantages explained hereinabove.

### BRIEF DESCRIPTION OF THE DRAWINGS

Exemplary embodiments of the invention are shown schematically in the drawings and explained in more detail in the description hereinafter. Like reference signs are used for elements illustrated in the various drawings having a similar effect, for which reason a repeated description of the elements has been omitted.

### Shown are:

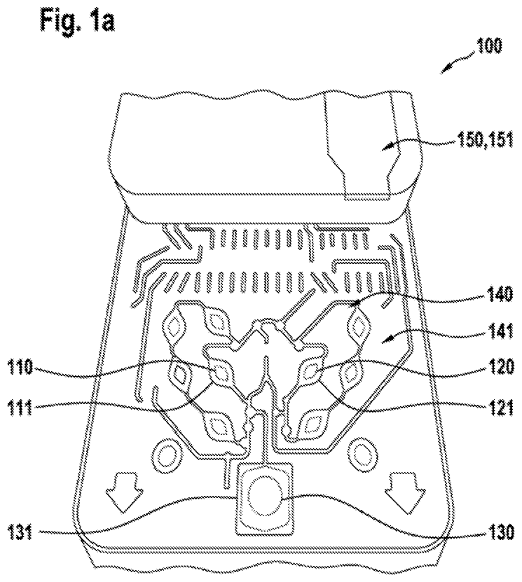

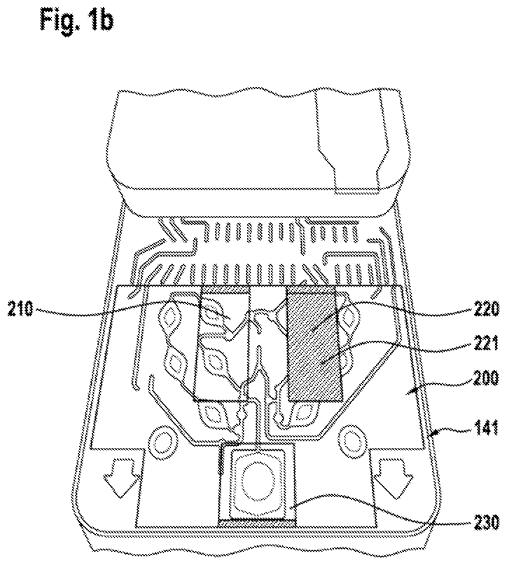

FIGS. 1a-c a first exemplary embodiment of the adhesive film according to the invention and the device according to the invention,

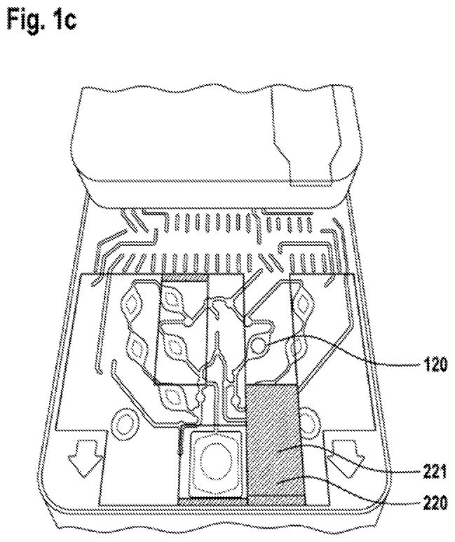

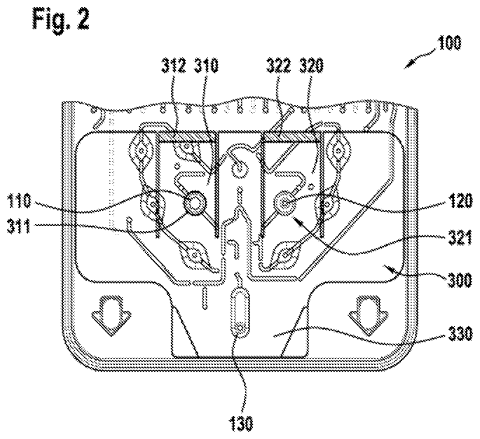

FIG. 2 a second exemplary embodiment of the adhesive film according to the invention and the device according to the invention,

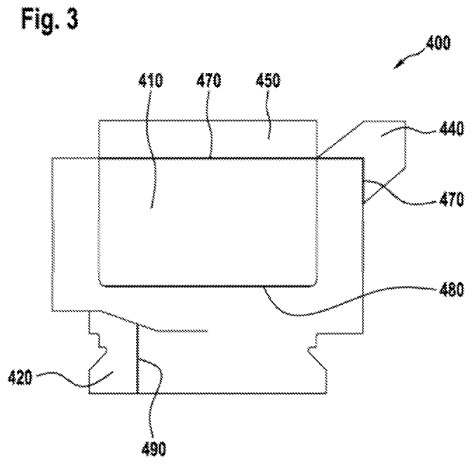

FIG. 3 a third exemplary embodiment of the adhesive film according to the invention and

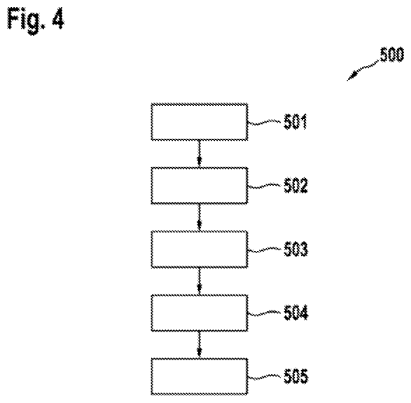

FIG. 4 a flowchart of an exemplary embodiment of the usage according to the invention.

### EMBODIMENTS OF THE INVENTION

FIGS. 1a, 1b, and 1c show an exemplary embodiment of the device 100 according to the invention and the adhesive film 200 according to the invention.

The device 100 can, e.g., be a microfluidic cartridge 100 as explained hereinabove and preferably comprises an introduction chamber 150 for introducing a sample, whereby the sample can comprise a human body fluid such as sputum, blood, urine, or a swab. In the situation shown in FIG. 1, the sample has already been introduced into the introduction chamber 150, and the introduction chamber 150 is closed by the associated lid 151. FIG. 1 also shows a section of the fluidic network 140 of the cartridge 100, whereby the network 140 is arranged in a transparent layer 141 of the cartridge and made of, e.g., polycarbonate. As indicated, the fluidic network 140 comprises multiple channels that connect multiple chambers with one another. The cartridge 100 and the associated fluidic network 140 can, e.g., be designed to perform a quantitative real-time polymerase chain reaction (abbreviated as qPCR) to detect pathogens, whereby the performance of the qPCR can be observed and measured through the transparent chambers.

In this example, the cartridge 100 comprises, in addition to the sample introduction chamber 150, a first opening 110 and a second opening 120, which respectively lead into a first mastermix reagent chamber 111 and a second mastermix reagent chamber 121. These openings 110, 120 are in this case designed as recesses in the transparent layer 141 and can be used to introduce PCR beads suitable for the respective analysis into the master mix reagent chambers 111, 121 at any time.

FIG. 1b shows the cartridge 100 with the adhesive film 200 applied. The adhesive film 200 can, e.g., be a film such as 3M™ 9795R microfluidic diagnostic tape, which is trimmed and structured in the manner hereinafter. In this example, the adhesive film 200 comprises a first tab 210 covering the first opening 110, a second tab 220 covering the second opening 120, and a third tab 230 covering a third opening 130 to a removal chamber 131 of the cartridge 100. The tabs 210, 220, 230 are formed by incisions in the adhesive film 200 and thus represent a first incised region 210, a second incised region 220, and a third incised region 230 of the adhesive film 200. The outer edge of the adhesive film 200 is additionally trimmed, thus being structured such that the entire top surface of the transparent layer 141 is not adhered to. As illustrated in FIG. 1b, the second tab 220 comprises a protective film 221 on the adhesive side of the adhesive film 200, which protective film can be peeled away so that the second tab 220 does not adhere to the top surface of the transparent layer 141. As a result, the protective film 221, which can be peeled away, is arranged on the side of the adhesive film 200 facing the second opening 120. FIG. 1c shows that the second tab 220 can therefore be readily moved away from the second opening 120, in particular folded away, to make the second opening 120 accessible to the user for, e.g., the introduction of a PCR bead into the second master mix reagent chamber 121. The protective film 221 can then be peeled away, and the second tab 220 can also be adhered to the transparent layer 141. Once processing of the cartridge 100 has been completed, substances, in particular a processed sample, can be removed from the removal chamber 131 via the third opening 130. As shown in FIG. 1b, the third tab 230 does not comprise the earlier protective film and is, e.g., adhering. Nevertheless, if an adhesive conventionally utilized for adhesive tapes is used, then the third opening 131 can be made accessible for removal, preferably by pulling away the tab 230.

FIGS. 2 and 3 a, b show further exemplary embodiments 300, 400 of the adhesive film according to the invention. All the adhesive films 200, 300, 400 shown are trimmed and/or structured so as not to cover an entire surface of the cartridge 100. The adhesive films can preferably be trimmed to size or bordered such that one or multiple regions of the transparent layer 141 are not covered, in particular regions above chambers or channels which are intended to be optically measured or read out. Structuring the adhesive film in this way is particularly advantageous in the case of a non-transparent adhesive film.

Like the adhesive film 200 shown in FIGS. 1b, c, the adhesive film 300 shown in FIG. 2 comprises three tabs 310, 320, 330, whereby the first tab 310 and the second tab 320 are also designed as incised regions 310, 320 for respectively covering the first opening 110 and the second opening 120, whereas the third tab 330 is designed differently, as a protrusion 330 of the adhesive film 300 for covering the third opening 130. In the illustrated state, the protective film has already been peeled away from the tabs, and the openings 110, 120, 130 have been adhered shut, as a result of which a remainder of the protective film 312, 322 can optionally remain attached to one end of the first tab 310 and to one end of the second tab 320, as illustrated, for improved manipulation of the tabs 310, 320. For example, the first tab 310 comprises a marking 311 in the form of a printed circle 311 such that a user is notified that a substance may be adhered to the first tab 310 within the circle 311 for insertion into the opening. The marking 311 is located above the first opening 110 of the cartridge 100, so that a soluble substance attached within the marking 311 can be detached from the first tab 310 via fluid through the first opening 110. To this end, the first tab 310 within the marking 311 can also comprise an adhesive for adhering the substance, whereby a different adhesive for the substance can, as needed, be different than for adhering the adhesive film 300 to the device 100. Alternatively, the adhesive film can also comprise no adhesive in a region covering an opening in order to reduce the risk of contamination of the device by adhesive. For example, the adhesive film 300 shown in FIG. 2 can comprise no adhesive in the region 321 of the second tab 320 over the second opening 320.

The adhesive film 400 shown in FIG. 3 comprises a first tab 410 which is wider than the other adhesive films 200, 300 shown in order to cover one or multiple, in particular two, introduction chambers, and a second tab 420 in order to cover a removal chamber in particular. In the state of the adhesive film 400 shown in FIG. 3, the adhesive film 400 can still comprise an opaque protective film, so that one of the two sides, in particular the adhesive side, of the adhesive film 400 is completely covered by the protective film. A first section 440 and a second section 450 of the adhesive film 400 are each preferably separated from a remainder of the adhesive film by an incision 470 or gap 470, whereby one region of the protective film extends across each of the incisions 470 and 470 in order to hold the sections 440, 450 and the remainder of the adhesive film 400 together. Via the first section 440 and the second section 450, the respective section 440, 450 together with the connected region of the protective film can thereby be removed from the remainder of the film 400 in order to expose an adhesive region of the remainder of the film 400, in particular for bonding the remainder to the cartridge 100. The first and second sections 440, 450 therefore make it easier to remove the protective film from the remainder of the adhesive film. In regions where the tabs 410, 420 are connected to the adhesive film, the protective film can comprise incisions 480, 490 in order to remove only one section of the protective film from the adhesive film at a time, in particular from the tabs 410, 420. As shown in FIG. 3, the incisions or gaps can also be designed as a continuous common incision 470 or gap 470. Such gaps or incisions 470, 480, 490 can also be provided in other embodiments of the adhesive film according to the invention, in particular in the exemplary embodiments shown in FIGS. 1a-c and 2 a, b.

The adhesive films 200, 300, 400 shown in FIGS. 1 to 3 can, e.g., be used according to an exemplary embodiment of the usage according to the invention. FIG. 4 shows a flow chart 500 comprising multiple steps. The usage can also be understood as (part of a) method 500 for introducing and/or removing substances via an opening of the cartridge. In a first step 501, an adhesive film according to the invention is provided as, e.g., an adhesive film 400 as shown in FIG. 3. The adhesive side of the entire adhesive film 400, which is preferably transparent, can initially be covered by a protective film. The adhesive film and the protective film preferably comprise incisions 470, 480, 490. By virtue of the incisions 480, 490 of the protective film, a first section of the protective film can be removed in a second step 502 in order to expose a first section of the adhesive side of the adhesive film and adhere it to the device, e.g. the cartridge. The tabs 410, 420 formed by incisions 470 in the adhesive film are preferably still covered by sections of the protective film, as also described hereinabove. For example, after removal of the first section of the protective film, further sections of the protective film are located on the first and second tabs 410, 420 of the adhesive film 400 shown in FIG. 3. The first step 501 and the second step 502 can optionally also be performed during the manufacture of the cartridge.

According to a third step 503, one or multiple substances are introduced into one or multiple openings of the cartridge, for which purpose the not yet adhering first tab 410 is folded away from these openings. Subsequently, in a fourth step 504, the protective film is removed from the first tab 410, and the first tab 410 is also adhered to the cartridge so that these openings are covered by the tab. Depending on the choice of adhesive and the surface properties of the cartridge, the first tab 410 can be detached from the cartridge again non-destructively when sufficient force is applied, or alternatively not detached, for example in order to introduce further substances. According to one advantageous embodiment, the protective film can in an optional fifth step 505 also be removed from the second tab 420 in order to seal openings in the cartridge 100 located under the second tab 420 using the second tab 420. For example, the fifth step 505 can be performed after a further substance has been introduced into an opening below the second tab in the cartridge or after a substance, e.g. a fluid processed in the cartridge, has been removed and the opening is intended to be closed for, e.g., disposal of the cartridge.

1. An adhesive film for sealing an opening of a microfluidic device, wherein the adhesive film comprises a protective film.

2. The adhesive film according to claim 1, wherein:
the adhesive film comprises a first tab, in particular for configured to cover the opening, and
the first tab comprises at least a section of the protective film.

3. The adhesive film according to claim 2,
wherein the first tab comprises a first incised region of the adhesive film.

4. The adhesive film according to claim 2, wherein the adhesive film comprises a second tab configured to cover a further opening of the device.

5. The adhesive film according to claim 4, wherein the first tab and/or the second tab includes a protrusion configured to respectively move the first or the second tab.

6. The adhesive film according to claim 1, wherein the adhesive film comprises no adhesive in a region covering the opening.

7. The adhesive film according to claim 1, wherein a section of the adhesive film is separated from a remainder of the adhesive film by an incision or gap and connected via a section of the protective film.

8. The adhesive film according to claim 1, wherein the first tab of the adhesive film, in comprises a marking for attaching/adhering a substance.

9. A microfluidic device, comprising an adhesive film according to claim 1.

10. The device according to claim 9, wherein an opening covered by the adhesive film leads into a reagent-chamber.

11. The device according to claim 10, wherein the reagent chamber comprises a reagent.

12. The device according to claim 1, wherein:
the adhesive film is arranged on the device such that a first tab of the adhesive film covers an opening, and a second tab covers a further opening, and
at least portions of the first tab and/or the second tab are formed by incisions in the adhesive film.

13. The device according to claim 12, wherein:
the tab comprises a protective film that is configured to be peeled away, and
the protective film that is configured to be peeled away is arranged on a side facing the opening.

14. The device according to claim 1, wherein the adhesive film is structured and/or trimmed such that no entire surface of the device is covered by the adhesive film, and at least one chamber of the device is not covered by the adhesive film.

15. Usage of an adhesive film according to claim 1 by a microfluidic device, wherein an opening of a microfluidic device is covered by the adhesive film and sealed after a substance has been introduced into the device via the opening or after a substance has been removed from the device through the opening.

16. The adhesive film according to claim 1, wherein the opening of the microfluidic device is an opening for feeding or removing substances.

17. The adhesive film according to claim 9, wherein the microfluidic device is a a microfluidic cartridge.

18. The device according to claim 11, wherein:
the reagent chamber is a mastermix reagent chamber, and
the mastermix reagent chamber comprises a mastermix reagent.
